(19) United States
(12) Patent Application Publication
(10) Pub. No.: US 2008/0177965 A1
(43) Pub. Date: Jul. 24, 2008

(54) DATA BACKUP DEVICE AND DATA BACKUP METHOD

(76) Inventors: Kenichi HAGA, Kanagawa (JP); Seiji Sakaki, Kanagawa (JP); Shigeyuki Ochiai, Kanagawa (JP)

Correspondence Address: MCDERMOTT WILL & EMERY LLP, 600 13TH STREET, NW, WASHINGTON, DC, 20005-3096, US

(21) Appl. No.: 12/016,596

(22) Filed: Jan. 18, 2008

(30) Foreign Application Priority Data
Jan. 19, 2007 (JP) P. 2007-009990

(51) Int. Cl. G06F 12/16

(52) U.S. Cl. 711/162; 711/E12.103

(57) ABSTRACT

A backup data validity deciding flag 11 showing whether backup data is in a state of validity or invalidity is used to shelter data stored in a backup source storing medium 20 to a backup destination storing medium 21 and the flag 11 is changed to a validity. Further, when the data stored in the backup destination storing medium 21 is returned to the backup source storing medium 20, the flag 11 is changed to an invalidity. When the flag 11 shows the invalidity, the data is not returned. That is, when the backup data is returned once, the data cannot be returned again until a next sheltering process of the data arises.

### BACKGROUND OF THE INVENTION

1. Field of the Invention

The present invention relates to a data backup device and a data backup method for backing up data.

2. Description of the Related Art

Usually, when data that may possibly disappear due to any of factors is backed up, a procedure is ordinarily carried out that the data as an object is sheltered to another storing medium and the data sheltered to another storing medium is returned to an original storing medium as required.

When processes such as sheltering or returning are carried out to protect information of a high secrecy from an attack such as tampering, an encoding process, a decoding process or a process for inspecting a propriety may be sometimes carried out together (see Patent Document 1).

FIG. 21 is a diagram showing a procedure of a sheltering process, a returning process and an updating process of a backup source in a usual data backup method. In the drawing, symbols a, b and c respectively show procedures at the time of the sheltering process, the returning process and the updating process of the backup source. That is, when a backup device shelters the data of a backup source area to a backup destination area, the backup device generates identifying information and stores the identifying information together. Further, when the backup device returns the data of the backup destination area to the backup source area, the backup device examines the stored identifying information.

Patent Document 1: JP-T-2004-531086

However, in the above-described usual data backup method, below-described problems arise. When the data of the backup destination area is returned to the backup source area, the data of the backup source area is updated, and then, the backup data is returned again, the contents of the backup source area are returned to an original state before the data is updated, which possibly leads to an inconvenience.

Further, when the data in the backup destination area is altered, it is effective to generate identifying information such as a hush value when the data is sheltered and inspect a propriety by using the identifying information at the time returning the data in order to detect the alteration and prevent the return of the backup data. However, when even the identifying information is replaced by a value generated on the basis of the altered backup data, the alteration cannot be detected to lead to an inconvenience by illegal data.

Further, since a processing load or a consumed electric power is increased proportionally to the quantity of the backup data, when a data backup function is installed in a device, the electric power of the entire part of the device is prevented from being saved.

### SUMMARY OF THE INVENTION

Thus, it is an object of the present invention to provide a data backup device and a data backup method that can prevent updated contents of a backup source are returned to an original state by a returning process. Further, it is another object of the present invention to provide a data backup device and a data backup method that can prevent a returning process of altered backup data and avoid a risk that the contents of a backup source are illegally operated. Further, it is a still another object of the present invention to provide a data backup device and a data backup method in which the decrease of a processing load or a consumed electric power can be anticipated.

To achieve the above-described objects, the present invention provides a data backup device that shelters data stored in a first storing medium in a second storing medium. The data backup device comprises: a data transfer unit that shelters the data stored in the first storing medium in the second storing medium and returns the sheltered data to the first storing medium; a flag unit that shows whether the data stored in the second storing medium is valid or invalid; and a transfer managing unit that allows the data transfer unit to shelter the data and sets the flag unit to a validity, when the data stored in the first storing medium is sheltered in the second storing medium, and on the other hand, allows the data transfer unit to return the data and sets the flag unit to an invalidity when the data stored in the second storing medium is returned to the first storing medium. Thus, the updated contents of a backup source can be prevented from being returned to an original state by a returning process. Further, the returning process of altered backup data can be prevented and a risk can be avoided that the contents of the backup source are illegally operated.

The data backup device further comprises: a write managing unit that retains the write of the data when the flag unit is valid at the time of writing the data in the first storing medium, allows the data transfer unit to return the data stored in the second storing medium, releases the write of the retained data after the data is returned, and allows the data transfer unit to shelter the data stored in the first storing medium that is updated after the data is completely written. Thus, the contents of a backup destination storing medium (a second storing medium) can be constantly updated so as to be the same as the contents of a backup source storing medium (a first storing medium). Accordingly, even when the data stored in the backup source storing medium disappears due to an unexpected factor, the data can be reset to a state before a disappearance.

Further, the write managing unit divides the backup source storing medium and the second storing medium respectively into a plurality of areas to manage addresses showing the divided areas of the first storing area and addresses showing the divided areas of the second storing medium so as to be coordinated with each other, and when the write managing unit writes the data in the area of the first storing medium, the write managing unit allows the data transfer unit to return the data and shelter the data between the area of the first storing medium and the area of the second storing medium. Thus, the backup destination storing medium can be automatically updated by a little consumed electric power and a processing load.

The backup device further comprises: a power managing unit that sets the power of the first storing medium to on or off for each area. When the write managing unit writes the data in the area of the first storing medium, the write managing unit instructs the power managing unit to set the power in the area of the first storing medium shown by the address to on before the data is returned and set the power to off after the data is sheltered. As described above, the power during the backup is diligently controlled, so that a consumed electric power can be reduced.

The data backup device further comprises: a power managing unit that sets the power of the first storing medium to on or off for each area; and an interruption generating unit that generates an interruption in an external processor. When the write managing unit detects that the external processor writes data in the area of the first storing medium, the write managing unit instructs the interruption generating unit to generate an interruption, and after the power in the area of the first storing medium is set to on before the data is returned in accordance with a handler executed in the processor, the write managing unit instructs the power managing unit to set the power to on after the data is sheltered. As described above, an instruction for turning on the power is carried out under a software control by the processor so that the scale of a circuit of the data backup device can be reduced.

The data backup device further comprises: a power state detecting unit that detects the state of a power in the first storing medium when a process to the first storing medium is carried out; and an informing unit that informs a source requesting the process about the power of the first storing medium being turned off when the power of the first storing medium is turned off. Thus, the process can be shifted to a proper process as to whether the power of the backup source storing medium is turned on again or the process is shifted to other process, and then, a retrial is carried out.

The present invention provides a data backup device that shelters data stored in a first storing medium in a second storing medium. The data backup device comprises: a data transfer unit that shelters the data stored in the first storing medium in the second storing medium, generates identifying information exclusively coordinated with the contents of the data, and on the other hand, returns the sheltered data to the first storing medium, and evaluates the propriety of the sheltered data by using the identifying information; an identifying information storing unit in which the generated identifying information is stored; and a transfer managing unit that allows the data transfer unit to shelter the data when the data stored in the first storing medium is sheltered in the second storing medium, and on the other hand, allows the data transfer unit to return the data when the data stored in the second storing medium is returned to the first storing medium. Thus, even when the data is altered, a situation can be prevented that the even the identifying information is replaced by a value generated from the altered data so that the alteration cannot be detected.

Further, the data transfer unit evaluates the propriety of the sheltered data by using the identifying information, and then, erases or replaces the identifying information stored in the identifying information storing unit by another value. Thus, the contents of the backup source storing medium can be prevented from being returned to an original state by a returning process.

Further, when the data transfer unit returns the data, the data transfer unit evaluates the propriety of the data stored in the second storing medium by using the identifying information generated on the basis of the data stored in the second storing medium, when it is decided that the data is not proper data, the data transfer unit evaluates the propriety of the data stored in the second storing medium by using the identifying information generated on the basis of the data stored in the first storing medium, and when it is decided that the data is proper data, the data transfer unit informs a request source that the data whose propriety is certified is completely returned. Thus, as long as the contents of the backup source storing medium are ensured, the same data as that during sheltering can be used an influence by the alteration can be reduced.

In a data backup method, a data backup device shelters data stored in a first storing medium to a second storing medium. The data backup method comprises: a validity setting step that sets a flag showing whether the data stored in the second storing medium is valid or invalid to a validity when the data backup device shelters the data stored in the first storing medium to the second storing medium; and an invalidity setting step that sets the flag to an invalidity when the data backup device returns the data stored in the second storing medium to the first storing medium.

In a data backup method, a data backup device shelters data stored in a first storing medium to a second storing medium. The data backup method comprises: a generating step that generates identifying information exclusively coordinated with the contents of the data when the data backup device shelters the data stored in the first storing medium to the second storing medium; a step that stores the generated identifying information in an identifying information storing unit by the data backup device; and an evaluating step that evaluates the propriety of the sheltered data by using the identifying information when the data backup device returns the sheltered data to the first storing medium.

According to the present invention, updated contents of a backup source (a first storing medium) can be prevented from being returned to an original state by a returning process. Further, the returning process of altered backup data can be prevented and a risk can be avoided that the contents of the backup source are illegally operated. Further, the decrease of a processing load or a consumed electric power can be anticipated.

### BRIEF DESCRIPTION OF THE DRAWINGS

FIG. 1 is a diagram showing the structure of a periphery of a data backup device of an electronic device in a first embodiment.

FIG. 2 is a flowchart showing a control procedure of a data sheltering and returning process.

FIG. 3 is a diagram showing the structure of a periphery of a data backup device of an electronic device in a second embodiment.

FIG. 4 is a flowchart showing a control procedure of a writing process.

FIG. 5 is a diagram showing a corresponding relation between a backup source storing medium and a backup destination storing medium in a third embodiment.

FIG. 6 is a flowchart showing a control procedure of a writing process.

FIG. 7 is a diagram showing the structure of a periphery of a data backup device of an electronic device in a fourth embodiment.

FIG. 8 is a flowchart showing a control procedure of a data sheltering and returning process.

FIG. 9 is a flowchart showing a control procedure of a writing process.

FIG. 10 is a diagram showing the structure of a periphery of a data backup device of an electronic device in a fifth embodiment.

FIG. 11 is a flowchart showing a control procedure of a writing process until the generation of an interruption.

FIG. 12 is a flowchart showing the control procedure of the writing process by an instruction for turning on a power source from an interruption handler 40.

FIG. 13 is a flowchart showing the procedure of the interruption handler 40 executed by a processor 30.

FIG. 14 is a diagram showing a data backup operation during the writing process.

FIG. 15 is a diagram showing the structure of a periphery of a data backup device of an electronic device in a sixth embodiment.

FIG. 16 is a flowchart showing a procedure for deciding a power turning on state.

FIG. 17 is a diagram showing the structure of a periphery of a data backup device of an electronic device in a seventh embodiment.

FIG. 18 is a flowchart showing a control procedure of a data sheltering and returning process.

FIG. 19 is a flowchart showing a control procedure of a data sheltering and returning process in an eighth embodiment.

FIG. 20 is a flowchart showing a control procedure of a data sheltering and returning process in a ninth embodiment.

FIG. 21 is a flowchart showing a procedure for sheltering and returning data and updating a backup source in a usual data backup method.

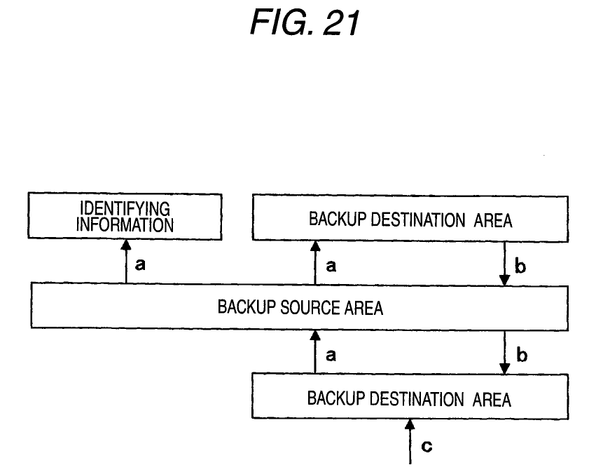

### DESCRIPTION OF THE PREFERRED EMBODIMENTS

An embodiment of a data backup device and a data backup method of the present invention will be described by referring to the drawings. The data backup method of this embodiment is applied to a data backup device mounted on an electronic device.

### First Embodiment

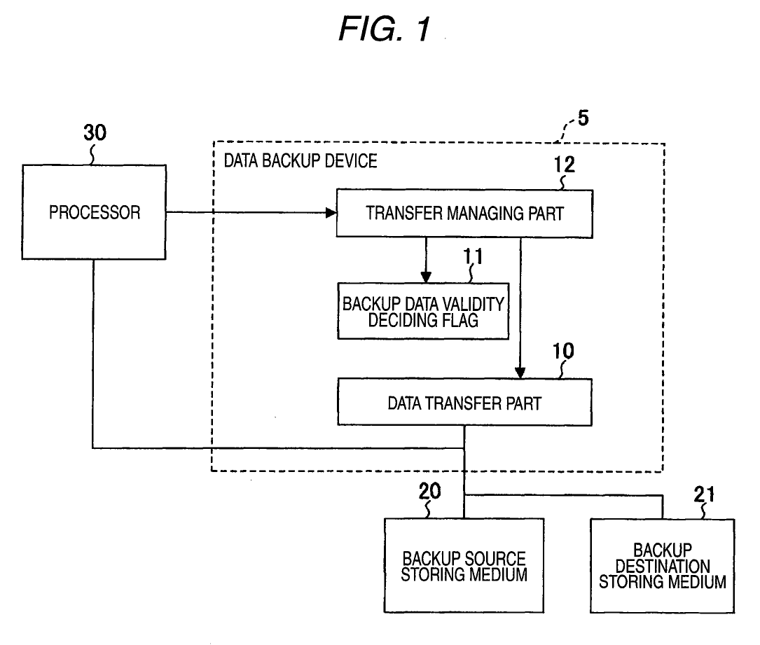

FIG. 1 is a diagram showing the structure of a periphery of the data backup device of the electronic device in a first embodiment. The electronic device includes a data backup device 5, a backup source storing medium 20, a backup destination storing medium 21 and a processor 30. The data backup device 5 is provided with a backup data validity deciding flag 11 as a flag unit, a transfer managing part 12 as a transfer managing unit and a data transfer part 10 as a data transfer unit.

The data transfer part 10 shelters and returns data between the backup source storing medium 20 and the backup destination storing medium 21. The backup data validity deciding flag 11 is a flag showing whether backup data is valid or invalid and cannot be written from a software executed by the processor 30. The transfer managing part 12 detects an instruction for transferring data from the processor 30 for executing the software to instructs the data transfer part 10 to shelter or return the data and changes the state of the backup data validity deciding flag 11. The functions of the above-described parts are realized by executing a processing program stored in a ROM by a CPU in the data backup device 5. The backup data validity deciding flag 11 is allocated to a RAM in the data backup device 5. This is applied to below-described embodiments.

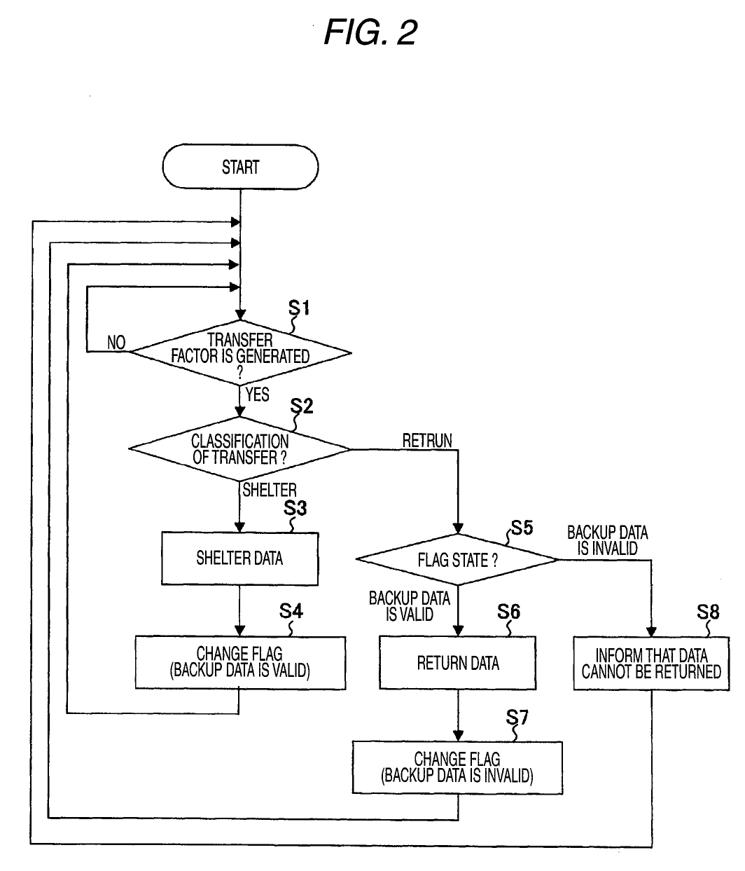

An operation of the data backup device having the above-described structure is shown. FIG. 2 is a flowchart showing a control procedure of a data sheltering and returning process. Initially, the transfer managing part 12 waits for the instruction for transferring the data from the processor 30 for executing the software (step S1). When the transfer managing part detects the instruction for transferring the data, the transfer managing part discriminates whether a classification of the transfer is to shelter the data or to return the data (step S2).

When the data is instructed to be sheltered, the transfer managing part 12 instructs the data transfer part 10 to transfer the data stored in the backup source storing medium 20 to the backup destination storing medium 21 (step S3). The data transfer part 10 shelters the data stored in the backup source storing medium 21 to the backup destination storing medium 21 in accordance with this instruction. When the transfer of the data (the data is sheltered) is completed, the transfer managing part 12 changes a value of the backup data validity deciding flag 11 to show that the backup data is valid (step S4). Then, the transfer managing part returns to the step S1 to wait for the instruction for transferring the data.

On the other hand, in the step S2, when the data is instructed to be returned, the transfer managing part 12 discriminates whether the value of the backup data validity deciding flag 11 shows either a state of validity or a state of invalidity (step S5). When the backup data is valid, the transfer managing part 12 instructs the data transfer part 10 to return the data sheltered in the backup destination storing medium 21 to the backup source storing medium 20 (step S6). The data transfer part 10 returns the data stored in the backup destination storing medium 21 to the backup source storing medium 20 in accordance with this instruction.

When the return of the data (the data is returned) is completed, the transfer managing part 12 changes the value of the backup data validity deciding flag 11 to show the backup data is invalid (step S7). Then, the transfer managing part returns to the step S1 to wait for the instruction for transferring the data.

On the other hand, in the step S5, when the backup data is invalid, the transfer managing part 12 does not instruct the data transfer part 10 to return the data and informs the processor 30 that the data cannot be transferred (step S8). Then, the transfer managing part returns to the step S1 to wait for the instruction for transferring the data.

As described above, according to the data backup device of the first embodiment, since when the backup data is returned once, the data cannot be returned again until the data is sheltered next, updated contents of a backup source can be prevented from being returned to an original state by a returning process.

Further, since the backup data validity deciding flag 11 cannot be written from the software executed by the processor 30, a danger can be also reduced that the backup data validity deciding flag 11 is altered to illegally operate the contents of the backup source.

As a specific example, in a device for treating a storing medium such as a CD, a DVD, etc. in which recording data such as music, an image or the like as an object whose copyright is protected is stored, as a method for protecting the copyright, a method has been used as one of ordinary methods that the number of times of copies is prescribed and the number of remaining times of copies is subtracted every time a copying operation is carried out. However, a risk arises that the number of remaining times of copies is obtained or rewritten to illegally operate the number of remaining times of copies. For instance, under a state that the number of remaining times of copies is five times, when the number of remaining times of is illegally obtained, if a copying operation is carried three times, the number of remaining times of copies is two times. However, at this timing, when the number of remaining times of copies that is illegally obtained is rewritten, the number of remaining times of copies is returned to five times, so that the effect of the protection of the copyright is lost. As compared therewith, this embodiment is effective when the data is protected from the operation of the number of times of copies.

### Second Embodiment

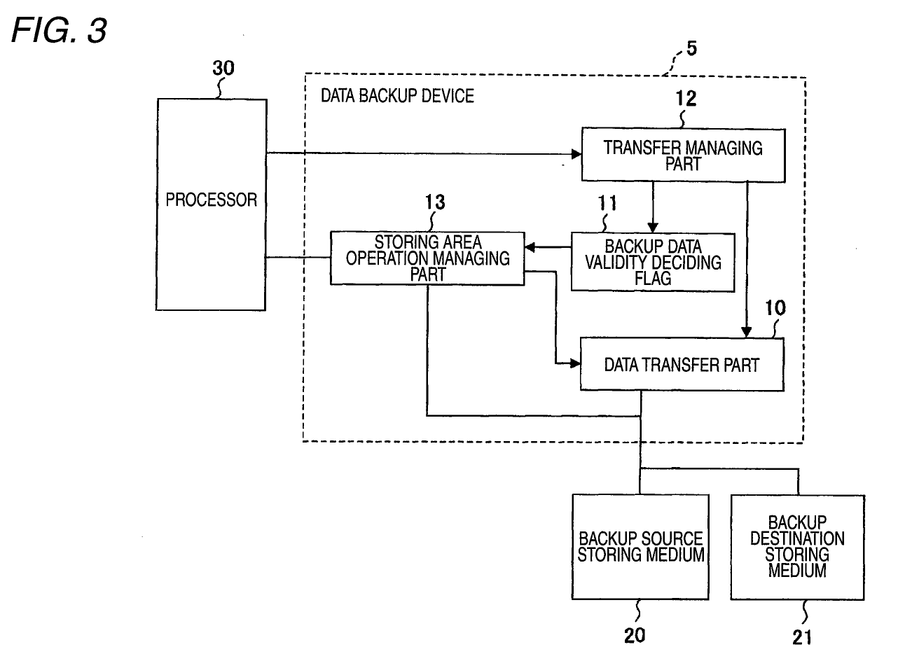

FIG. 3 is a diagram showing the structure of a periphery of a data backup device of an electronic device in a second embodiment. Components the same as those of the first embodiment are designated by the same reference numerals and an explanation thereof is omitted. As compared with the first embodiment, the data backup device of the second embodiment further includes a storing area operation managing part 13 as a storing area operation managing unit.

The storing area operation managing part 13 detects a process to a backup source storing area 20 from a processor 30 for executing software. When the storing area operation managing part 13 writes data in the backup source storing area 20, if backup data is valid, the storing area operation managing unit 13 carries out a series of operations of retaining a writing operation, requesting a data transfer part 10 to return the data, releasing the retention of the writing operation and requesting the data transfer part 10 to shelter the data. The function of the storing area operation managing part 13 is also realized, as described above, by executing a processing program stored in a ROM by a CPU in the data backup device 5.

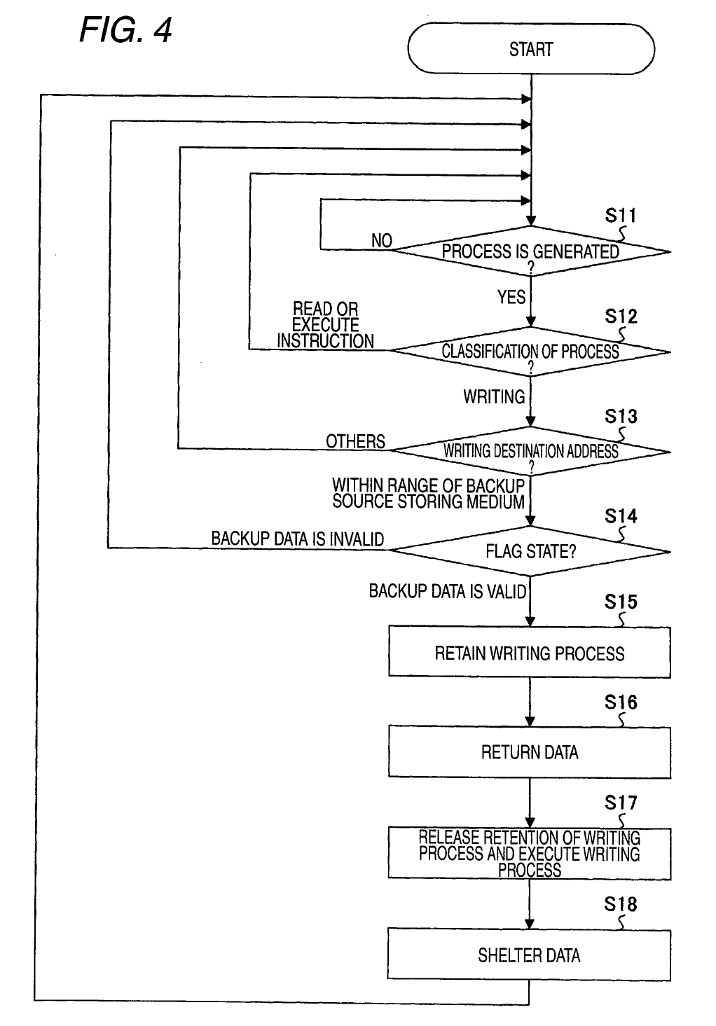

An operation of the data backup device having the above-described structure is shown. Since a control procedure of a data sheltering and returning process is the same as the procedure shown in the flowchart of FIG. 2 in the first embodiment, an explanation thereof is omitted. FIG. 4 is a flowchart showing a control procedure of a writing process.

Initially, the storing area operation managing part 13 waits for the generation of a process to a storing medium from the processor 30 executing the software (step S11). When the storing area operation managing part 13 detects this process, the storing area operation managing part 13 discriminates whether a classification of the process is to execute an instruction, to read data or to write data (step S12).

When the classification of the process is to execute the instruction or to read the data, the storing area operation managing part 13 returns to the step S11 to wait for a next process. On the other hand, in the step S12, when the classification of the process is to write the data, the storing area operation managing part 13 discriminates an address of a writing destination storing medium or a storing medium on which the data is written (step S13).

When the address of the writing destination storing medium is located outside the range of the backup source storing medium 20, the storing area operation managing part 13 returns to the step S11 to wait for a next process. On the other hand, when the address of the writing destination storing medium is located within the range of the backup source storing medium, the storing area operation managing unit 13 discriminates whether a backup data validity deciding flag 11 shows either that the backup data is valid or that the backup data is invalid (S14).

When the backup data validity deciding flag 11 shows that the backup data is invalid, the storing area operation managing part 13 returns to the step S11 to wait for a next process. On the other hand, when the backup data validity deciding flag 11 shows that the backup data is valid, the storing area operation managing part 13 retains a writing process (S15) and instructs the data transfer part 10 to return the backup data sheltered in a backup destination storing medium 21 to the backup source storing medium 20 (step S16). The data transfer part 10 returns the data stored in the backup destination storing medium 21 to the backup source storing medium 20 in accordance with the instruction.

When the data is completely returned, the storing area operation managing part 13 releases the retention of the writing process to carry out the writing process (step S17). Then, when the writing process is completed, the storing area operation managing part 13 instructs the data transfer part 10 to shelter again the data of the backup source storing medium 20 to the backup destination storing medium 21 (step S18). The data transfer part 10 shelters the data stored in the backup source storing medium 20 to the backup destination storing medium 21 in accordance with the instruction. After that, the storing area operation managing part 13 returns to the step S11 to wait for a next process.

As described above, according to the data backup device of the second embodiment, the same effects of the first embodiment can be anticipated. In addition thereto, when the data is backed up once, the contents of the backup destination storing medium can be automatically updated to be constantly the same as those of the backup source storing medium. Accordingly, even when the data stored in the backup source storing medium disappears due to any unexpected factor, the data can be returned to a state immediately before a disappearance.

### Third Embodiment

Since the structure of a data backup device in a third embodiment is the same as that of the second embodiment, the same reference numerals are used and an explanation thereof is omitted.

In the data backup device in the third embodiment, a data transfer part 10 can set a range of transferring data not to an entire part of a backup source storing medium 20 or an entire part of a backup destination storing medium 21, but to a restricted range.

Further, a storing area operation managing part 13 divides the backup source storing medium 20 into storing areas whose sizes are smaller than the size of the entire part and manages respectively the addresses of divided storing areas to be coordinated with the addresses of the backup destination storing medium 21. Further, when the storing area operation managing part 13 detects a factor of writing data in the backup source storing medium 20, while a backup data validity deciding flag 11 shows that backup data is valid, the storing area operation managing part 13 instructs to return and shelter again the data between the divided storing area to which a writing address belongs and a storing area in the backup destination storing medium 21 managed by the storing area operation managing part 13 correspondingly thereto.

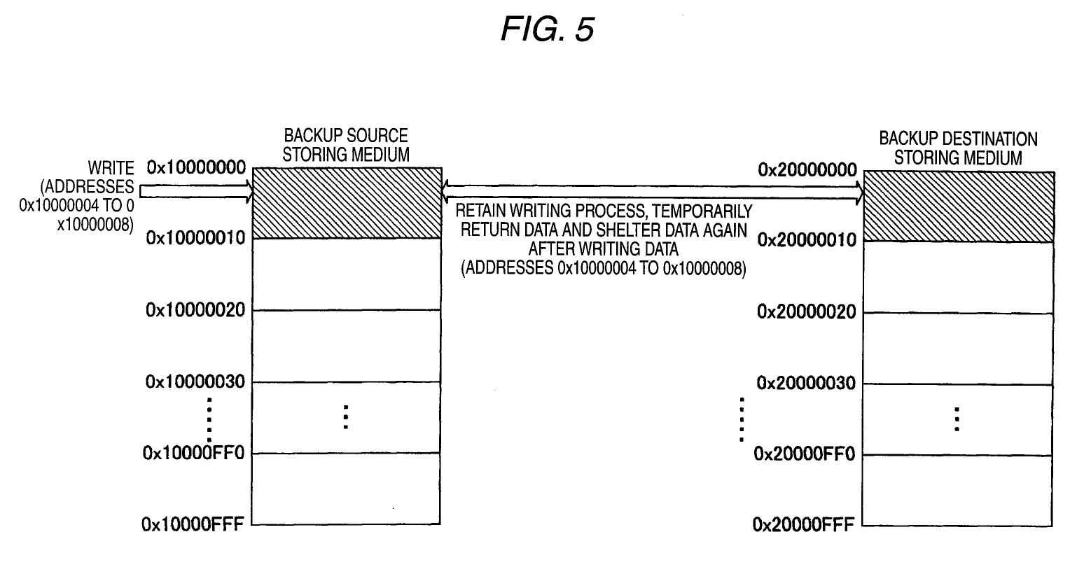

FIG. 5 is a diagram showing a corresponding relation between the backup source storing medium and the backup destination storing medium in the third embodiment. For instance, the backup source storing medium 20 is arranged at an address 0x10000000 to an address 0x10000FFF, and the backup destination storing medium 21 is arranged at an address 0x20000000 to an address 0x20000FFF.

The storing area operation managing part 13 manages the backup source storing medium 20 for 1×10 byte units. Further, the storing area operation managing part 13 coordinates areas of an address (0x10000000+N) to an address (0x1000000F+N) of the backup source storing medium 20 with areas of an address (0x20000000+N) to an address (0x2000000F+N) of the backup destination storing medium 21. Here, a variable is a multiple of 0×10.

When the storing area operation managing part 13 detects a writing process to an address 0x10000004 to an address 0x10000008, if the backup data is valid, the storing area operation managing part retains the writing process. The storing area operation managing part 13 instructs the data transfer part 10 to partly return the data from the areas of an address 0x20000000 to an address 0x2000000F to the areas of an address 0x10000000 to an address 0x1000000F.

Then, when the writing process is completed, the storing area operation managing part 13 instructs the data transfer part 10 to shelter the data gain from the areas of the address 0x10000000 to the address 0x1000000F to the areas of the address 0x20000000 to the address 0x2000000F.

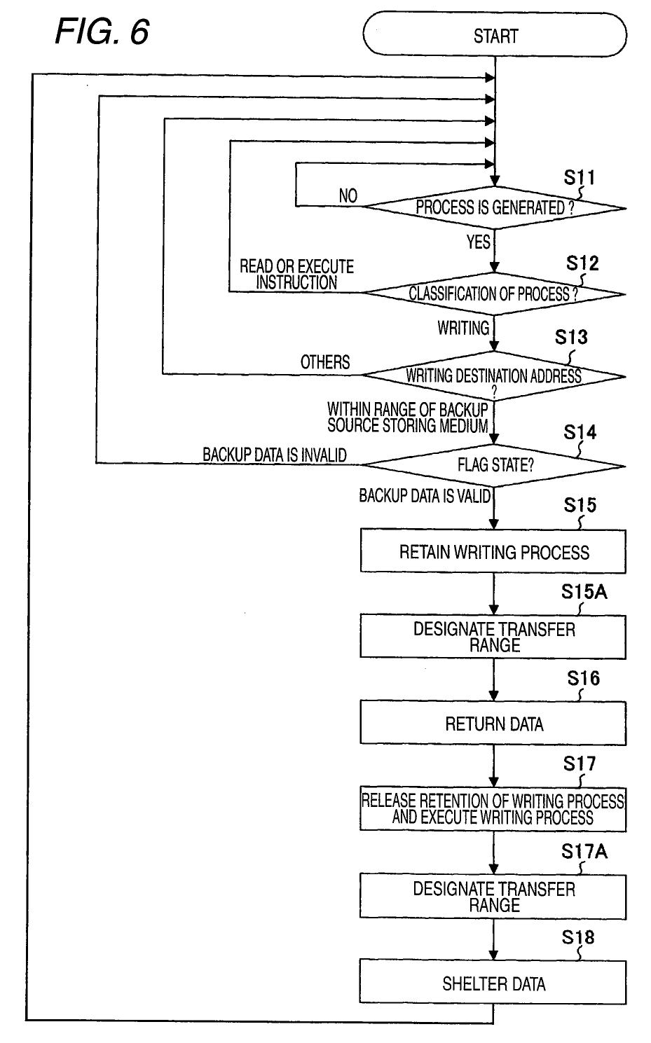

The data backup device having the above-described structure is shown. Since a control procedure of a data sheltering and returning process is the same as the procedure shown in the flowchart of FIG. 2 in the first embodiment, an explanation thereof is omitted. FIG. 6 is a flowchart showing a control procedure of the writing process. Step processes the same as the step processes shown in the flowchart of FIG. 4 in the second embodiment are designated by the same step numbers and an explanation thereof is omitted.

When the storing area operation managing part 13 retains the writing process in step S15, the storing area operation managing part 13 designates a transfer range to the data transfer part 10 (step S15A). The storing area operation managing part 13 instructs the data transfer part 10 to return the backup data sheltered in the backup destination storing medium 21 within the designated transfer range to the backup source storing medium (step s16). In accordance with this instruction, the data transfer part 10 returns the data stored in the backup destination storing medium 21 to the backup source storing medium 20 within the designated transfer range.

When the data is completely returned, the storing area operation managing part 13 releases the retention of the writing process to carry out the writing process (step S17). Then, when the writing process is completed, the storing area operation managing part 13 designates a transfer range to the data transfer part 10 (step S17A). The storing area operation managing part 13 instructs the data transfer part 10 to shelter again the data of the backup source storing medium 20 to the backup destination storing medium 21 within the designated range (step S18). In accordance with the instruction, the data transfer part 10 shelters the data stored in the backup source storing medium 20 to the backup destination storing medium 21 within the designated transfer range. Then, the storing area operation managing part 13 returns to the step S11 to wait for a next process.

As described above, according to the data backup device of the third embodiment, effects the same as those of the first and second embodiments can be anticipated. In addition thereto, the backup destination storing medium can be automatically updated with a little consumed electric power and a processing load.

### Fourth Embodiment

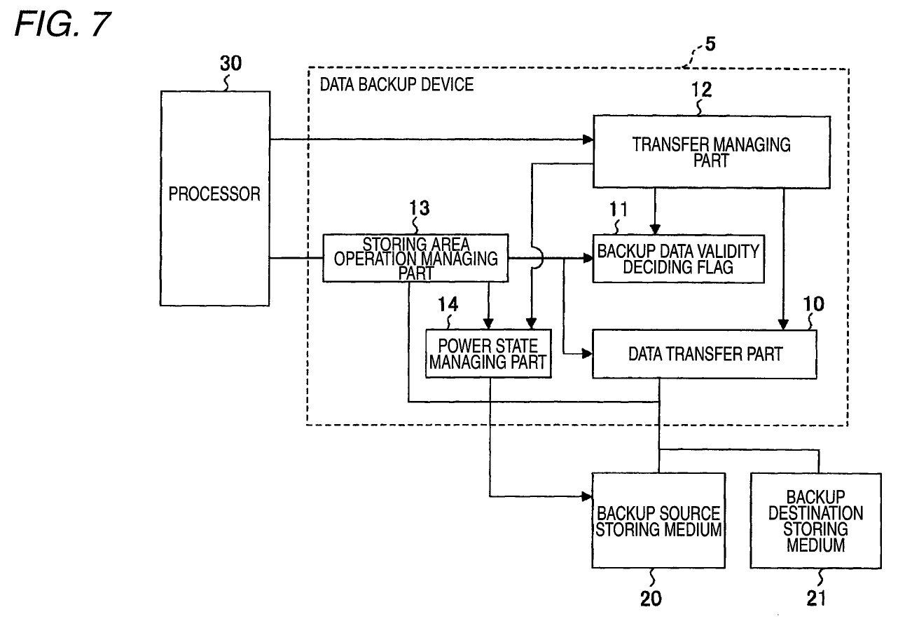

FIG. 7 is a diagram showing the structure of a periphery of a data backup device of an electronic device in a fourth embodiment. Components the same as those of the second embodiment are designated by the same reference numerals and an explanation thereof is omitted. As compared with the second embodiment, the data backup device of the fourth embodiment further includes a power managing part 14 as a power managing unit for turning on and off a power source to a backup source storing medium 20 in accordance with an instruction of a storing area operation managing part 13.

Here, the storing area operation managing part 13 instructs, at the time of retaining a writing process, the power managing part 14 to turn on the power source of the backup source storing medium 20. After the retention of the writing process is released and data is completely sheltered again, the storing area operation managing part 13 instructs the power managing part 14 to turn off the power source of the backup source storing medium 20.

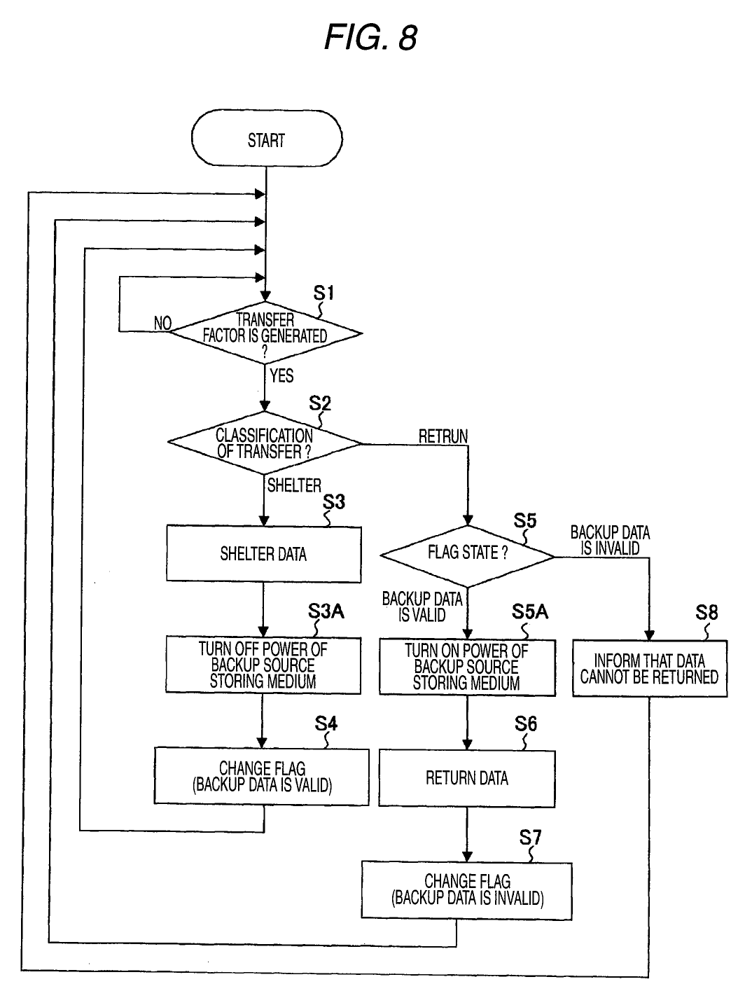

An operation of the data backup device having the above-described structure is shown. FIG. 8 is a flowchart showing a control procedure of a data sheltering and returning process. Step processes the same as those of FIG. 2 in the first embodiment are designated by the same step numbers and an explanation thereof is omitted, and different step processes are described herein.

In step S3, a transfer managing part 12 instructs a data transfer part 10 to shelter data. After the data is completely sheltered, the transfer managing part 12 instructs the power managing part 14 to turn off the power source of the backup source storing medium 20 (step 3A). In accordance with this instruction, the power managing part 14 turns off the power source of the backup source storing medium 20.

Further, in step S5, when a backup data validity deciding flag is valid, the transfer managing part 12 instructs the power managing part 14 to turn on the power source of the backup source storing medium 20 (step 5A). In accordance with this instruction, the power managing part 14 turns on the power source of the backup source storing medium 20. After the power source of the backup source storing medium 20 is turned on, the transfer managing part 12 instructs the data transfer part 10 to return the data in step S6.

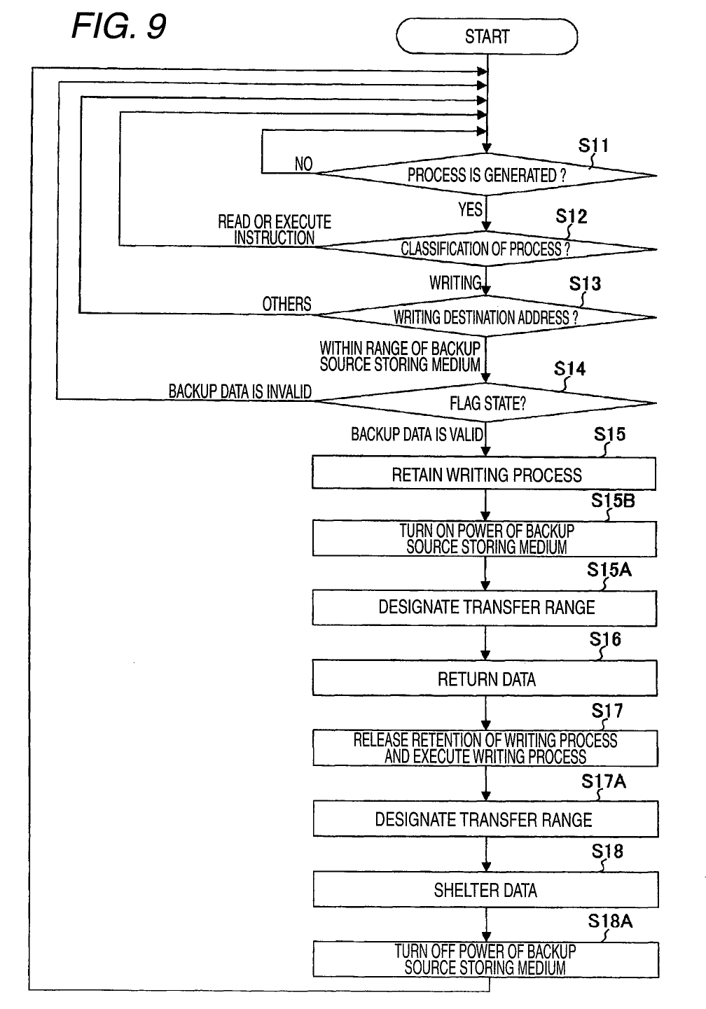

FIG. 9 is a flowchart showing a control procedure of a writing process. Step processes the same as the step processes shown in the flowchart of FIG. 6 in the third embodiment are designated by the same step numbers and an explanation thereof is omitted, and different step processes are described herein.

In step S15, after the storing area operation managing part 13 retains the writing process, the storing area operation managing part 13 instructs the power managing part 14 to turn on the power source of the backup source storing medium 20 (step S15B). In accordance with this instruction, the power managing part 14 turns on the power source of the backup source storing medium 20.

After the power of the backup source storing medium 20 is turned on, in step S15A, the storing area operation managing part 13 designates a transfer range to the data transfer part 10. In step S16, the storing area operation managing part 13 instructs the data transfer part 10 to return the data.

Further, in step S17, when the retention of the writing process is released, the storing area operation managing part 13 designates a transfer range to the data transfer part 10 in step S17A. In step S18, the storing area operation managing part 13 instructs the data transfer part 10 to shelter the data. The storing area operation storing part 13 instructs the power managing part 14 to turn off the power source of the backup source storing medium 20 (step S18A). In accordance with this instruction, the power managing part 14 turns off the power source of the backup source storing medium 20. After that, the storing area operation managing part returns to the process of the step S11.

Here, a range where the power is turned on in the step S15A is only a range of a divided storing area to which a writing destination address belongs. For instance, when the storing area operation managing part 13 manages the backup source storing medium 20 (see FIG. 5), if the storing area operation managing part detects the writing process to an address 0x10000004 to an address 0x10000008, the storing area operation managing part 13 instructs the power managing part 14 to turn on a power of only the range of an address 0x10000000 to an address 0x1000000F. When the storing area operation managing part also manages a backup destination storing medium 21, the storing area operation managing part may similarly instruct the power managing part 14 to turn on a power of only the range of a corresponding area.

According to the data backup device of the fourth embodiment, effects the same as those of the first embodiment can be anticipated. In addition thereto, since the power during a backup is diligently controlled, a consumed electric power can be reduced.

### Fifth Embodiment

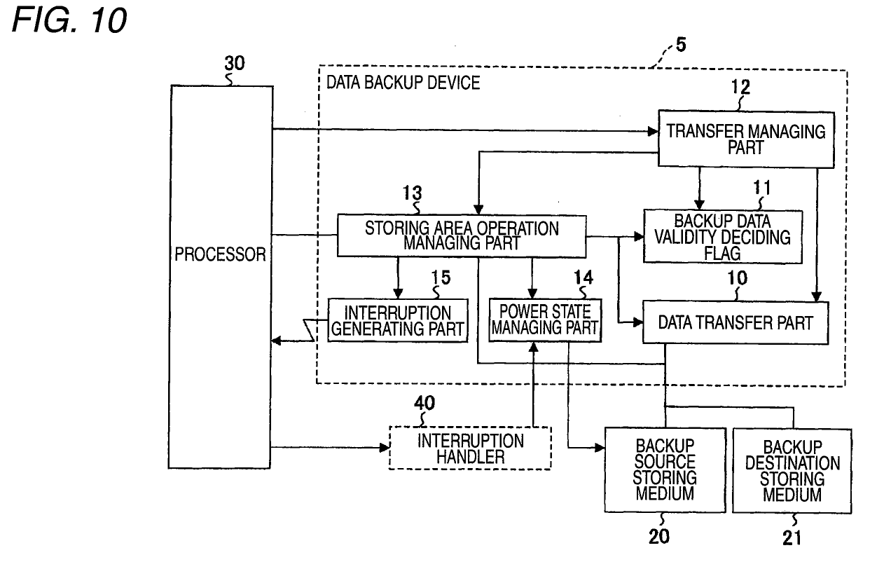

FIG. 10 is a diagram is a diagram showing the structure of a periphery of a data backup device of an electronic device in a fifth embodiment. Components the same as those of the fourth embodiment are designated by the same reference numerals and an explanation thereof is omitted. As compared with the fourth embodiment, the data backup device of the fifth embodiment further includes an interruption generating part 15 as an interruption generating unit for generating an interruption to a processor 30 in accordance with an instruction from a storing area operation managing part 13.

The storing area operation managing part 13 instructs the interruption generating part 15, at the time of retaining a writing process, to generate the interruption. Further, a power managing part 14 instructs to turn on a power to a backup source storing medium 20 not in accordance with the instruction from the storing area operation managing part 13, but in accordance with an instruction by executing an interruption handler 40 from the processor 30. The interruption handler 40 is software stored in a ROM in the processor 30.

An operation of the data backup device having the above-described structure is shown. In the fifth embodiment, a process of the step S11 to the step S15 of FIG. 9 in the fourth embodiment and a process of the step S15B to the step S18A are treated not as a series of continuous operations, but as independent operations.

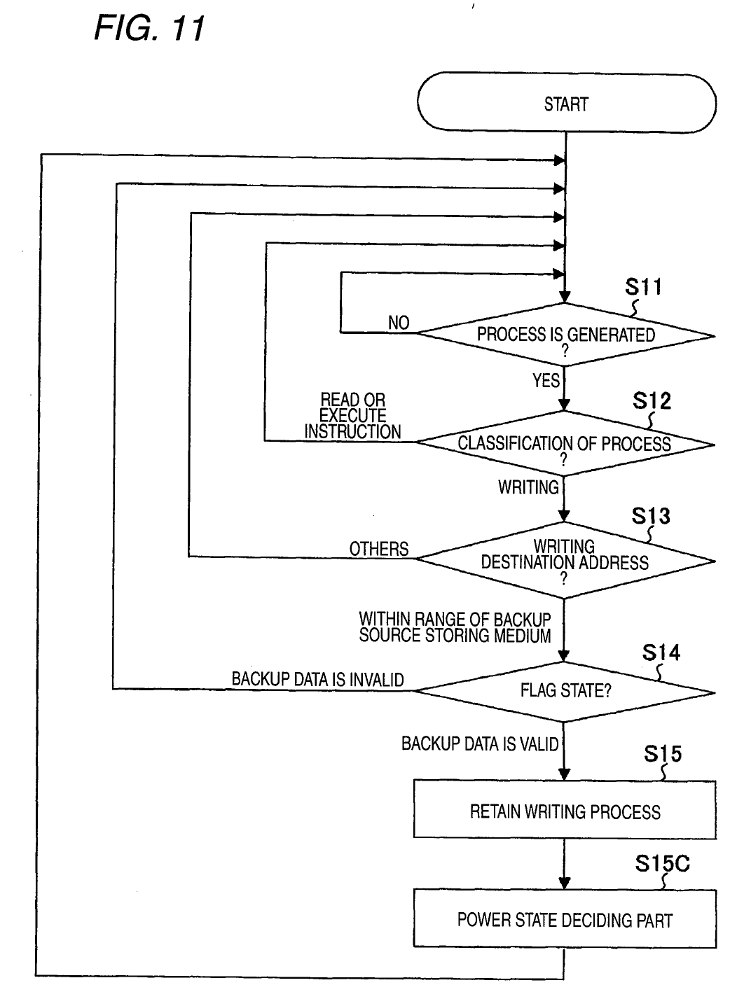

FIG. 11 is a flowchart showing a control procedure from the generation of the interruption to the writing process. Step processes the same as the step processes shown in the flowchart of FIG. 9 in the fourth embodiment are designated by the same step numbers and an explanation thereof is omitted, and different step processes are described herein.

In the step S11 to the step S14, when the storing area operation managing part 13 detects the writing process to the backup source storing medium 20 under a state that the power of the backup source storing medium 20 is turned off, the storing area operation managing part retains the writing process in the step S15 and instructs the interruption generating part 15 to generate the interruption (step S15C). In accordance with the instruction, the interruption generating part 15 generates the interruption to the processor 30. Then, the storing area operation managing part 13 returns to the process of the step S11.

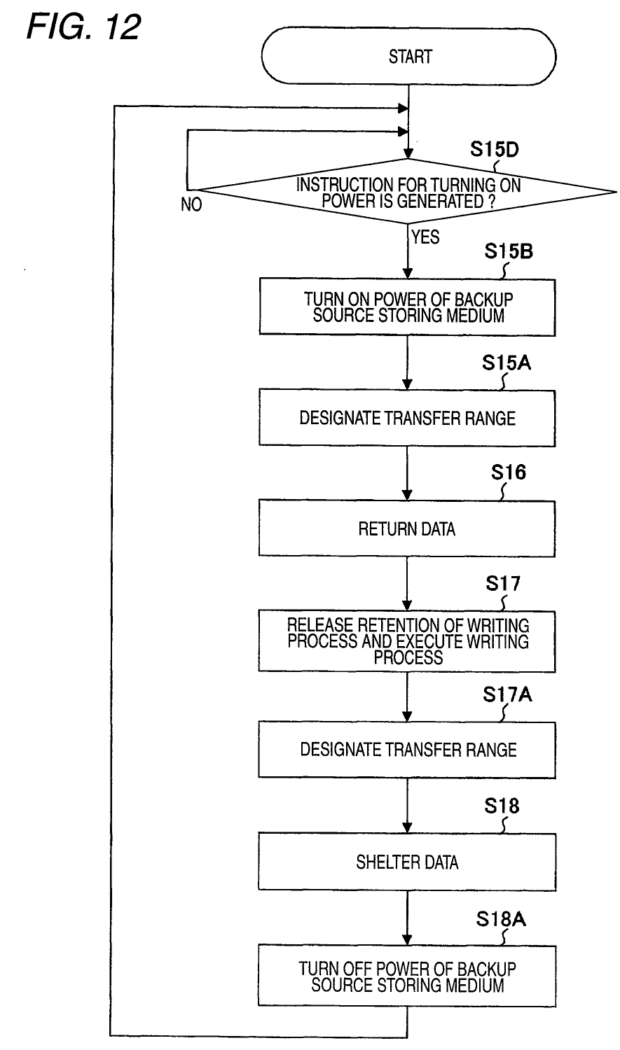

FIG. 12 is a flowchart showing a control procedure of the writing process by an instruction for turning on the power from the interruption handler 40. Step processes the same as the step processes shown in the flowchart of FIG. 9 in the fourth embodiment are designated by the same step numbers and an explanation thereof is omitted, and different step processes are described herein.

The power managing part 14 waits for the detection of the instruction for turning on the power from the interruption handler 40 (step S15D). When the power managing part 14 detects the instruction for turning on the power, the power managing part 14 turns on the power source of the backup source storing medium 20 in step S15B. Then, in the steps S16 to S18A, the power managing part carries out a series of processes of turning on the power source of the backup source storing medium 20, returning data, releasing all retained writing processes, sheltering again the data after the data is completely written and turning off the power source of the backup source storing medium. Then, the power managing part returns to the process of the step S15D.

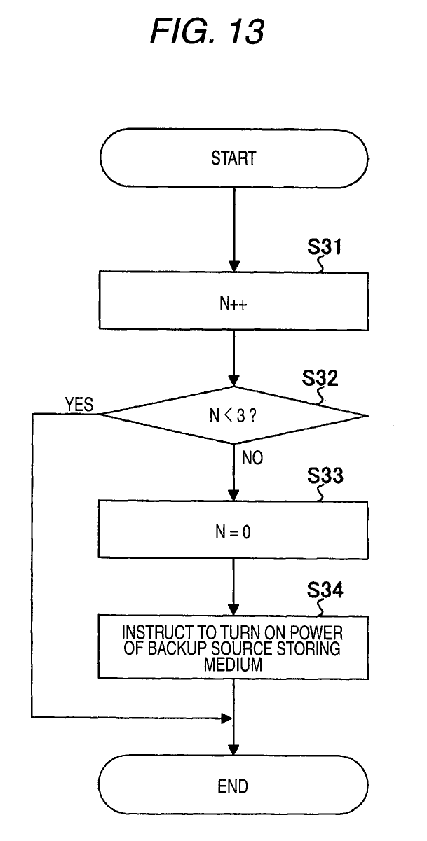

FIG. 13 is a flowchart showing a procedure of the interruption handler 40 executed by the processor 30. The processor 30 adds a value 1 to a counter value N every time the interruption is generated (step S31) to discriminate whether or not the counter value N reaches a value 3 (step S32). Here, the counter value N is stored in a RAM in the processor 30 and an initial value is 0.

In step S32, when the counter value N reaches the value 3, the processor 30 returns the counter value N to the initial value 0 (step S33). Then, the processor 30 instructs the power managing part 14 to turn on the power (step S34). Then, the processor finishes the processes. It is to be understood that the counter value N may be an arbitrary value.

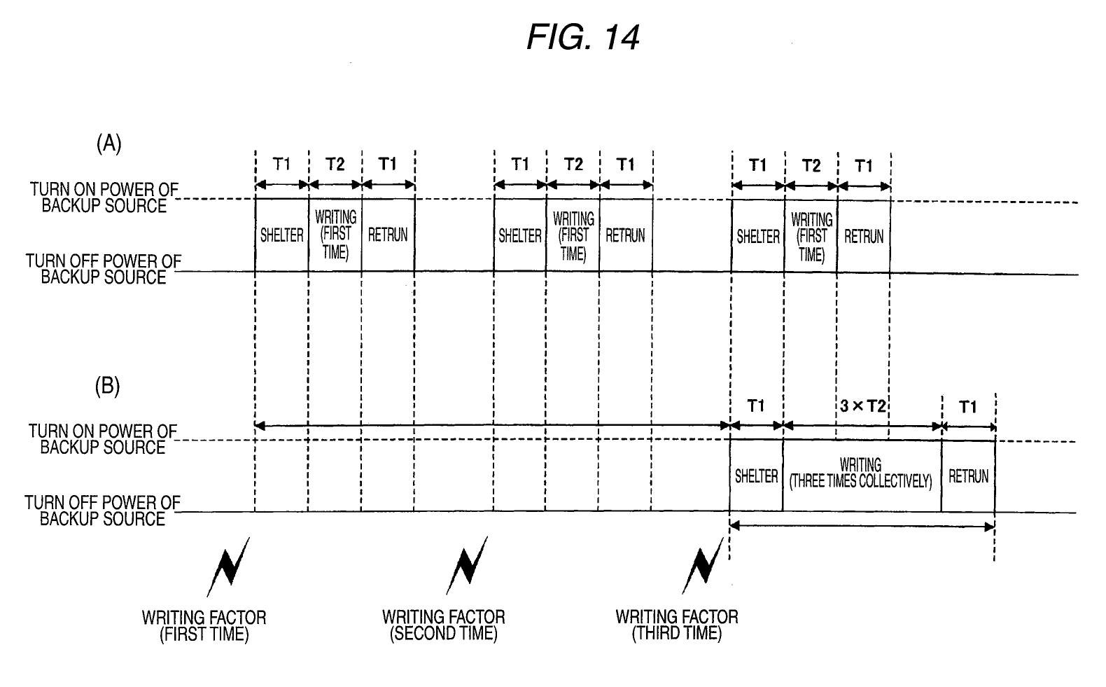

FIG. 14 is a diagram showing a data backup operation during the writing process. Here, T1 designates a data sheltering time, T2 designates a writing time and T3 designates a data returning time. Further, it is assumed that backup data is valid and the writing process to the backup source storing medium 20 is generated three times at the timing shown in FIG. 14. In FIG. 14(A), as shown in the fourth embodiment, the backup data is sheltered, the data is written and the data is returned every time the writing process is carried out. That is, a series of processes of retaining the writing process, turning on the power, returning the data, releasing all retained writing processes and sheltering again the data after the writing process is completed are generated three times.

On the other hand, in FIG. 14(B), when a writing factor (an interruption is generated) arises three times, the interruption handler 40 collectively carries out the data backup operation. Accordingly, the power source of the backup source storing medium 20 is not turned on until a third interruption is generated, so that a consumption of an electric power can be suppressed and a processing time can be reduced by 4×T1.

As described above, according to the data backup device of the fifth embodiment, a processing load and a consumed electric power necessary for sheltering and returning the data two times can be reduced. Further, since an instruction for turning on the power is carried out under a software control, the scale of a circuit can be decreased.

### Sixth Embodiment

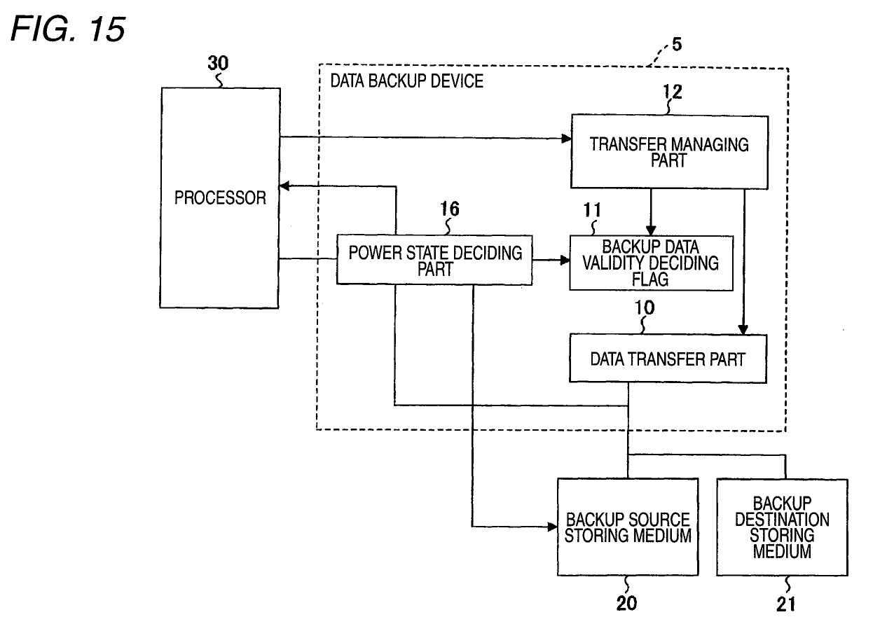

FIG. 15 is a diagram showing the structure of a periphery of a data backup device of an electronic device in a sixth embodiment. Components the same as those of the first embodiment are designated by the same reference numerals and an explanation thereof is omitted. As compared with the first embodiment, the data backup device of the sixth embodiment further includes a power state deciding part 16 as a power state deciding unit. When the power state deciding part 16 detects that data is read or written in a data backup source storing medium 20 or an instruction is carried out by executing software of a processor 30, the power state deciding part 16 decides whether the power source of the data backup source storing medium 20 is turned on or off, and when the power is turned off, the power state deciding part informs the processor 30 that the power is turned off.

An operation of the data backup device having the above-described structure is shown. Since a control procedure of a data sheltering and returning process of the sixth embodiment is the same as the procedure shown in the flowchart of FIG. 2 in the first embodiment, an explanation thereof is omitted.

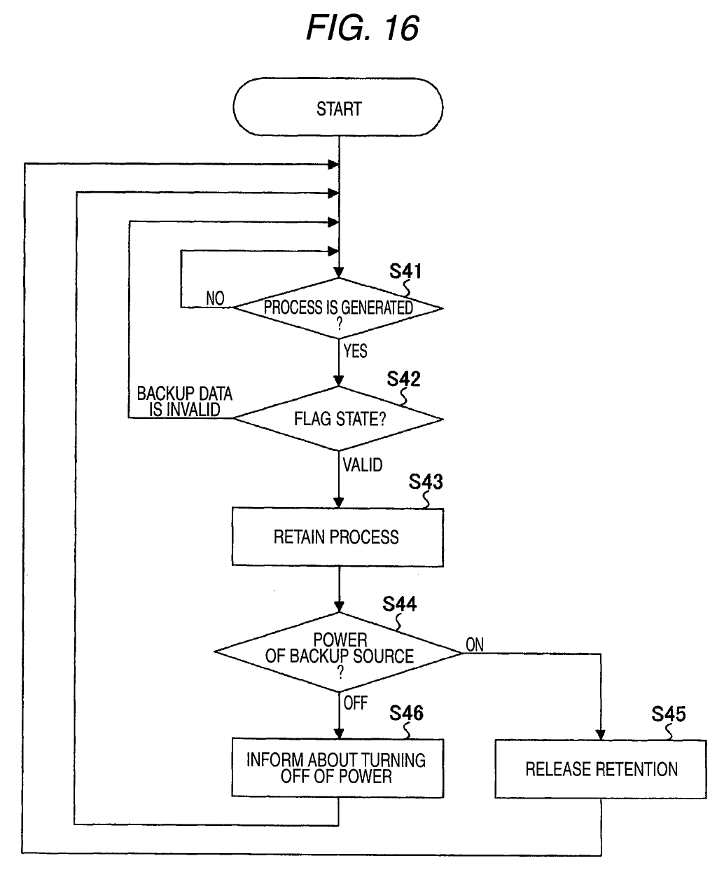

FIG. 16 is a flowchart showing a procedure for deciding a power turning on state. The power state deciding part 16 waits for reading or writing data to the storing medium or executing the instruction by executing the software of the processor 30 (step S41). When this process is generated, the power state deciding part discriminates whether a backup data validity deciding flag 11 is in a state that backup data is valid or invalid (step S42).

When the backup data is invalid, the power state deciding part 16 does not retain the reading or writing process of the data to the storing medium or the executing process of the instruction to return to the step S41 and waits for the generation of a next reading or a writing process or a next executing process of an instruction.

On the other hand, when the backup data is valid, the power state deciding part 16 temporarily retains the reading or writing process to the storing medium or the executing process of the instruction (step S43). Then, the power state deciding part 16 discriminates whether the power source of the backup source storing medium 20 is turned on or off (step S44).

When the power source of the backup source storing medium 20 is turned on, the power state deciding part 16 releases the retention of the reading or writing process to the storing medium or the executing process of the instruction (step S45). Thus, the reading or writing process to the backup source storing medium 20 or the executing process of the instruction is carried out. Then, the power state deciding part 16 returns to the step S41 to wait for the generation of a next reading or writing process or a next executing process of an instruction.

On the other hand, in the step S44, when the power source of the backup source storing medium 20 is turned off, the power state deciding part 16 informs the processor 30 that since the power source is turned off, the reading or writing process to the backup source storing medium 20 or the executing process of the instruction cannot be carried out (step S46). Then, the power state deciding part 16 returns to the step S41 to wait for the generation of a next reading or writing process or a next executing process of an instruction.

After the data is backed up in the backup source storing medium 20, the backup source storing medium 20 is used as a working area for storing other data or its power source is turned off to save an electric power.

According to the data backup device of the sixth embodiment, after the software backs up the data, the software can detects whether the power source of the backup source storing medium is turned on or off to carry out a process meeting a state of turning on or off of the power source. For instance, a proper process can be carried out that the power source is turned on again or a process is shifted to other process, and then, the reading or writing process or the executing process of the instruction is retried.

### Seventh Embodiment

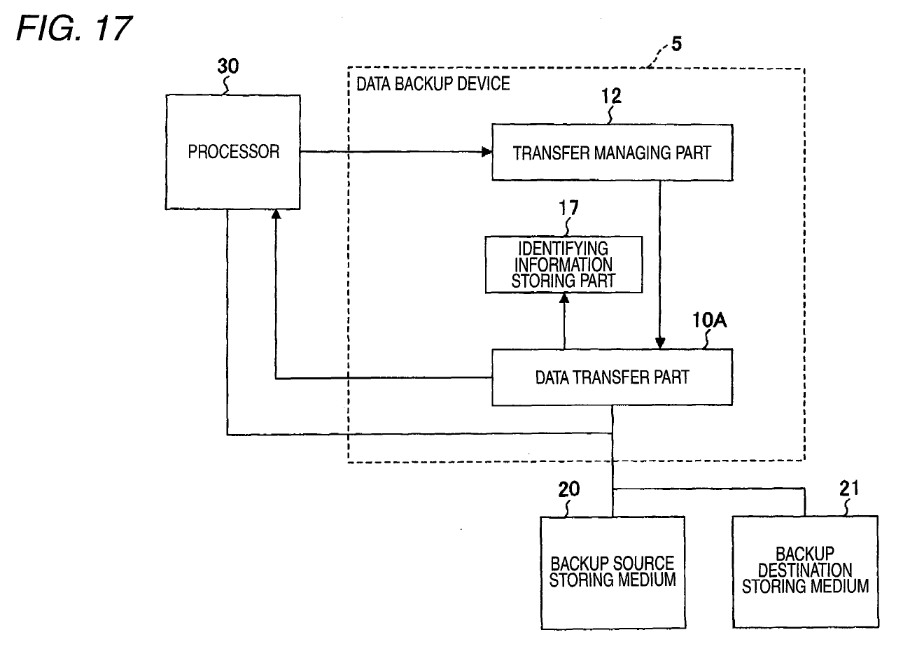

FIG. 17 is a diagram showing the structure of a periphery of a data backup device of an electronic device in a seventh embodiment. Components the same as those of the first embodiment are designated by the same reference numerals. This data back device 5 includes a data transfer part 10A, a transfer managing part 12 and an identifying information storing part 17 as an identifying information storing unit.

The data transfer part 10A shelters and returns data between a backup source storing medium 20 and a backup destination storing medium 21 and informs a processor 30 of a result thereof. The transfer managing part 12 detects an instruction for transferring the data from the processor 30 for executing software and instructs the data transfer part 10A to shelter or return the data. The identifying information storing part 17 is used as a part in which the identifying information of backup data is stored and data cannot be written from the software executed by the processor 30.

The identifying information of the backup data is formed on the basis of the contents of the data when the data transfer part 10A shelters the data, and is a value used for evaluating the propriety of the data when the data transfer part 10A returns the data. As the identifying information, for instance, a hush value is employed.

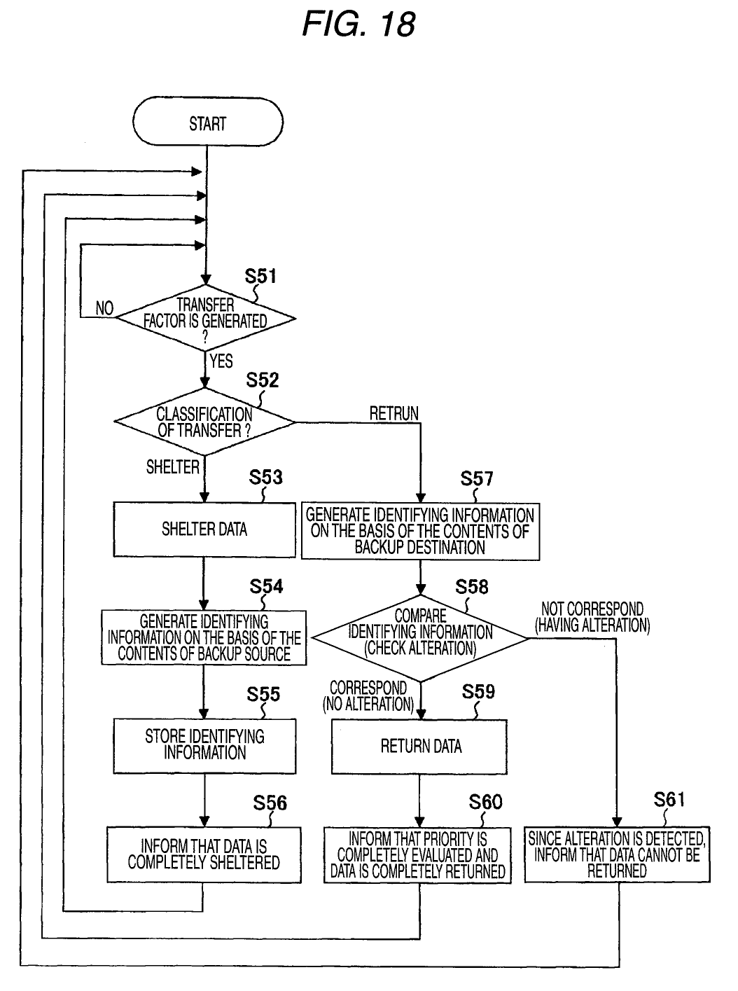

FIG. 18 is a flowchart showing a control procedure of a data sheltering and returning process. Initially, the transfer managing part 12 waits for the instruction for transferring the data from the processor 30 for executing the software (step S51). When the transfer managing part detects the instruction for transferring the data, the transfer managing part discriminates whether a classification of the transfer is either to shelter the data or to return the data (step S52).

When the data is instructed to be sheltered, the transfer managing part 12 instructs the data transfer part 10A to transfer the data stored in the backup source storing medium 20 to the backup destination storing medium 21 (step S53).

In accordance with this instruction, the data transfer part 10A transfers the data stored in the backup source storing medium 20 to the backup destination storing medium 21 and generates the identifying information on the basis of the backup data (step S54) and stores the generated identifying information in the identifying information storing part 17 (step S55).

Then, the data transfer part 10A informs the processor 30 that the data is completely sheltered (step S56). Then, the transfer managing part 12 returns to the step S51 to wait for a next instruction for transferring the data.

On the other hand, in the step S52, when the data is instructed to be returned, the transfer managing part 12 instructs the data transfer part 10A to generate the identifying information on the basis of the data sheltered to the backup destination storing medium 21 (step S57). The data transfer part 10A generates the identifying information on the basis of the data sheltered in the backup destination storing medium 21 and compares the generated identifying information with the identifying information stored in the identifying information storing part 17 to examine whether or not the data is altered while the data is sheltered in the backup destination storing medium 21 (step S58).

When the identifying information corresponds to each other, that is, when it is decided that the data is not altered while the data is sheltered to the backup destination storing medium 21, the data transfer part 10A returns the data sheltered in the backup destination storing medium 21 to the backup source storing medium 20 (step S59). After the data is completely returned, the propriety of the backup data is certified to inform the processor 30 that the return of the data is completed (step S60). Then, the transfer managing part 12 returns to the step S51 to wait for a next instruction for transferring the data.

On the other hand, in the step S58, when the identifying information does not correspond to each other, that is, when it is decided that the data is altered while the data is sheltered to the backup destination storing medium 21, the data transfer part 10A does not carry out the returning process and informs the processor 30 that the backup data is altered (step S61). Then, the transfer managing part 12 returns to the step S51 to wait for a next instruction for transferring the data. In this case, since the data is not returned, the backup data cannot be continuously used. Accordingly, a proper process such as a reconstruction of the data from an initial state is required.

According to the backup device of the seventh embodiment, the identifying information is stored in the identifying information storing part that cannot be written from the software executed in the processor 30 and protected. Thus, if the backup data should be altered, the identifying information could be prevented from being altered. Accordingly, a situation can be avoided that the identifying information is replaced by a value generated from altered backup data so that an alteration cannot be detected. As a result, a risk that illegal data leads to an inconvenience can be reduced.

### Eighth Embodiment

Since the structure of a data back up device in an eighth embodiment is the same as the structure of the seventh embodiment, the same reference numerals are used to omit an explanation thereof. In the eighth embodiment, as compared with the seventh embodiment, a data transfer part 10A has a function for erasing identifying information stored in an identifying information storing part 17 during returning backup data.

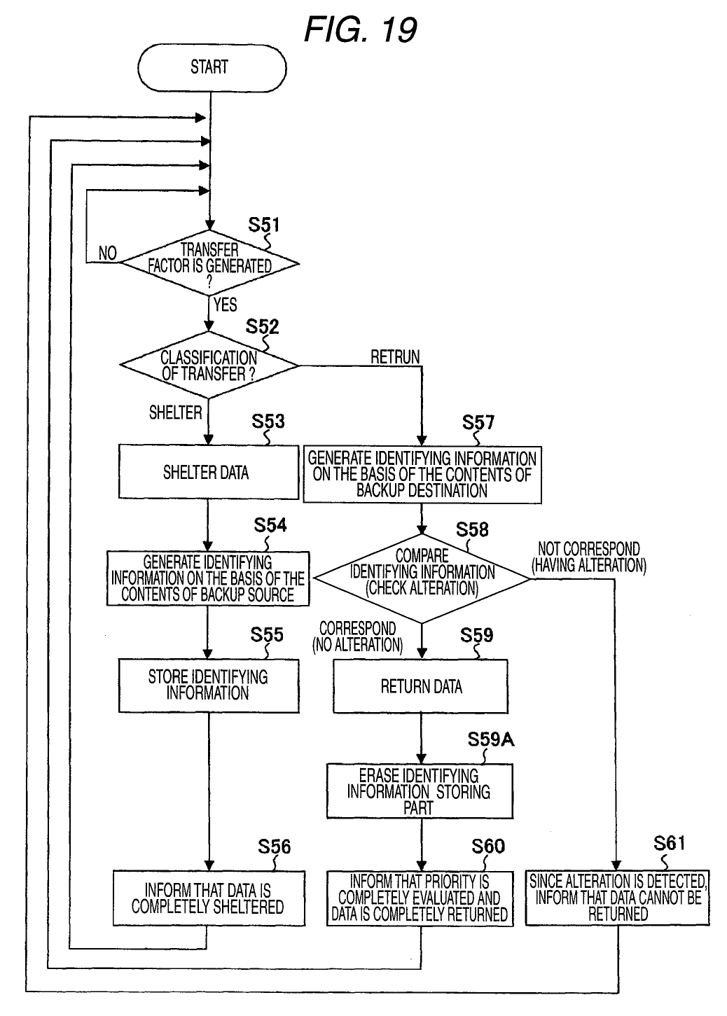

FIG. 19 is a flowchart showing a control procedure of a data sheltering and returning process in the eighth embodiment. Step processes the same as the step processes shown in the flowchart of FIG. 18 in the seventh embodiment are designated by the same step numbers to omit an explanation thereof, and different step processes are described herein.

In step S59, after the data transfer part 10A returns data sheltered to a backup destination storing medium 21 to a backup source storing medium 20, the data transfer part 10A erases the identifying information stored in the identifying information storing part 17 (step S59A). Then, in step S60, the data transfer part 10A informs a processor 30 that the propriety of the backup data is certified and the return of the data is completed.

According to the backup device in the eighth embodiment, since when the backup data is returned once, the identifying information of the backup data stored in the identifying information storing part 17 is erased, the backup data that is returned once cannot be returned again. Accordingly, the same effects as those of the seventh embodiment can be anticipated. Further, as in the first embodiment, the updated contents of a backup source can be prevented from being returned to an original state by the returning process.

### Ninth Embodiment

Since the structure of a data back up device in a ninth embodiment is the same as the structure of the seventh embodiment, the same reference numerals are used to omit an explanation thereof. In the ninth embodiment, as compared with the seventh embodiment, a data transfer part 10A further has a below-described function. That is, the data transfer part has the function in which when the data transfer part 10A detects that backup data stored in a backup destination storing medium 21 is altered, the data transfer part decides whether or not the state of a backup source storing medium 20 is maintained in the same state as that during sheltering data on the basis of identifying information stored in an identifying information storing part 17, and when it is decided that the same state is maintained, the data transfer part returns to a processor 30 the same response as that during completing the returning process of the data.

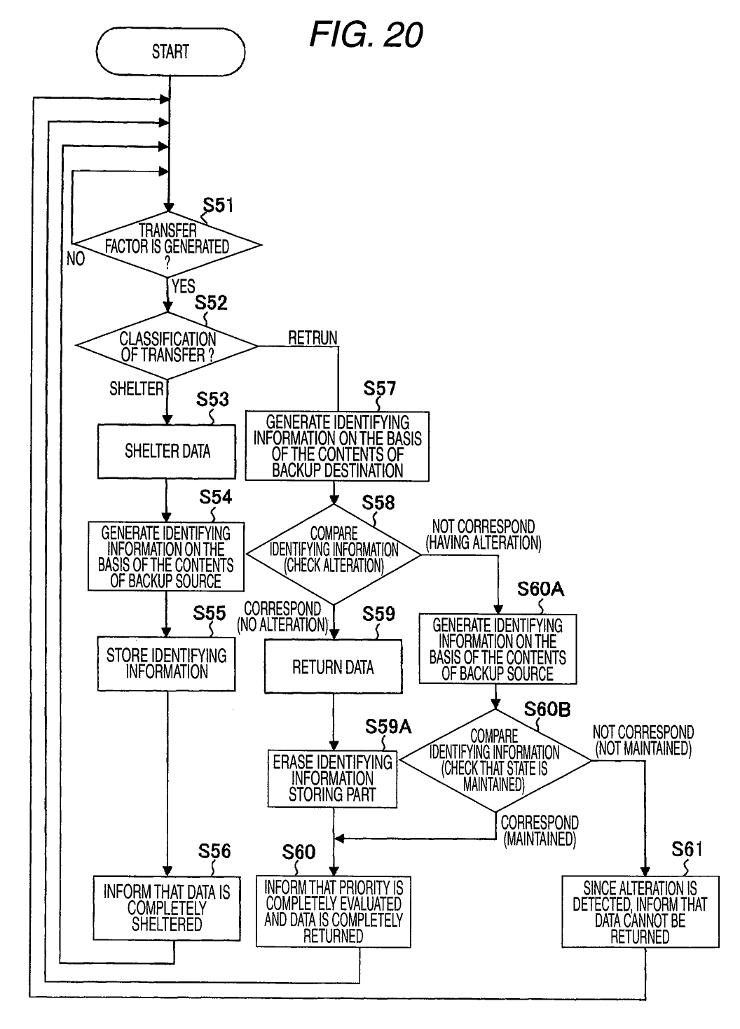

FIG. 20 is a flowchart showing a control procedure of a data sheltering and returning process in the ninth embodiment. Step processes the same as the step processes shown in the flowchart of FIG. 19 in the eighth embodiment are designated by the same step numbers to omit an explanation thereof, and different step processes are described herein.

In step S58, when the data transfer part 10A decides that the contents of the backup destination storing medium 21 are altered during returning the data, the data transfer part generates the identifying information by the same method as that during sheltering the data in step S54 on the basis of the contents of the backup source storing medium 20 (step 60A).

The data transfer part 10A compares the generated identifying information with the identifying information stored in the identifying information storing part 17 to examine whether or not the contents of the backup source storing medium 20 after sheltering the data changes due to causes such as switching off of a power or an overwriting process for other use (step S60B).

As a result of comparison, when the identifying information corresponds to each other, since the contents of the backup source storing medium 20 are maintained, the state of the backup source storing medium 20 is considered to be the same state during the completion of the returning process of the data to return the response to the processor 30 in step S60. Then, a transfer managing part returns to step S51 to wait for a next instruction for transferring the data.

On the other hand, as a result of comparison, when the identifying information does not correspond to each other, since the alteration of backup data is detected in step S61, the data transfer part returns to the processor 30 a response showing that the data cannot be returned. Then, the transfer managing part 12 returns to the step S51 to wait for a next instruction for transferring the data.

According to the data backup device in the ninth embodiment, if the backup data should be altered, when it is ensured that the contents of the backup source storing medium are maintained, the same data as that during sheltering the data can be used. Thus, an influence due to the alteration can be reduced.

The present invention is not limited to the structure of the above-described embodiment and any of structures that can achieve functions described in claims or the function of this embodiment can be employed.

For instance, the functions in the data backup devices of the above-described embodiments are respectively realized by executing the processing program stored in the ROM by the CPU in the data backup device 5, however, the functions may be realized by an integrated circuit that can be controlled by software.

Specifically, the data transfer part 10, the flag 11, the transfer managing part 12 and the processor 30 in the first embodiment are installed as one integrated circuit. Here, when the transfer managing part 12 is provided with a register in which data can be written by the software, the use of the register is set to a writing operation for instructing to shelter and write the data. The processor 30 executes the software for operating the register so that the sheltering and returning process of the data can be controlled.

Further, the backup source storing medium 20 or the backup destination storing medium 21 may be also installed so as to be included in one integrated circuit or may be installed so as to form an integrated circuit independent of the processor 30.

The above-described matter is not limited to the structure of the first embodiment and may be applied to the structures of other embodiments. The parts of the data backup device can be respectively installed as the integrated circuit and software for controlling it.

The data backup devices of the above-described embodiments can be respectively mounted on various kinds of electronic devices. For instance, the data backup device may be mounted on a security system for certifying an individual so that improper certifying data cannot be used.

To summarize the data backup devices described in the above-described embodiments respectively, below-described effects can be obtained. Namely, since the backup data validity deciding flag showing that the back up data is in a state of validity or invalidity is employed, and when this flag shows the invalidity, the backup data is not returned, the updated contents of the backup source can be prevented from being returned to an original state by the returning process. Further, since the flag cannot be written from external software, a danger can be reduced that the contents of the backup source are illegally operated by altering the flag. Further, when the writing process to the backup source arises during the validity of the backup data, the backup source and the backup destination are synchronously updated. Further, the power source of the backup source storing medium is controlled to be turned on only in an updated range only during an updating process. Accordingly, the processing load and the consumed electric power can be reduced. Further, the control of the power source is realized by the cooperating work of the software and hardware so that the reduction of the scale of a circuit or a more decrease of the consumed electric power can be anticipated. Further, when the backup data is sheltered, the identifying information of the backup data is stored in the identifying information storing part that cannot be altered from the software, and when the backup data is returned, the contents of the identifying information storing part are discarded, so that an inconvenience due to the return of the altered backup data can be avoided and the updated contents of the backup source can be prevented from being returned to an original state by the returning process. Further, when the alteration is detected, the propriety of the contents of the backup source is evaluated by using the identifying information. When it is decided that there is no alteration, the contents of the backup source are considered not to be altered and disappear and to be continuously used. The backup data can be also nullified. Accordingly, a strength to the alteration can be more improved.

A data backup method of the present invention is effective for an electronic device having a function for backing up data. For instance, in a device treating a storing medium such as a CD, a DVD or the like in which recording data such as music, an image, etc. as an object whose copyright is to be protected is stored, the data backup method of the present invention is effective when the data is protected from the number of times of copying processes. Further, the data backup method may be applied to a security system for certifying an individual so that illegally certifying data cannot be used.

What is claimed is:

1. A data backup device that shelters data stored in a first storing medium in a second storing medium, said data backup device, comprising:
a data transfer unit that shelters the data stored in the first storing medium in the second storing medium and returns the sheltered data to the first storing medium;
a flag unit that shows whether the data stored in the second storing medium is valid or invalid; and
a transfer managing unit that allows the data transfer unit to shelter the data and sets the flag unit to a validity, when the data stored in the first storing medium is sheltered in the second storing medium, and on the other hand, allows the data transfer unit to return the data and sets the flag unit to an invalidity when the data stored in the second storing medium is returned to the first storing medium.

2. The data backup device according to claim 1, further comprising:
a write managing unit that retains the write process of the data when the flag unit is valid at the time of writing the data in the first storing medium, allows the data transfer unit to return the data stored in the second storing medium, releases the write process of the retained data after the data is returned, and allows the data transfer unit to shelter the data stored in the first storing medium that is updated after the data is completely written.

3. The data backup device according to claim 2, wherein the write managing unit divides the first storing medium and the second storing medium respectively into a plurality of areas to manage addresses showing the divided areas of the first storing area and addresses showing the divided areas of the second storing medium so as to be coordinated with each other, and when the write managing unit writes the data in the area of the first storing medium, the write managing unit allows the data transfer unit to return the data and shelter the data between the area of the first storing medium and the area of the second storing medium.

4. The data backup device according to claim 3, further comprising:
a power managing unit that sets the power of the first storing medium to on or off for each area, wherein when the write managing unit writes the data in the area of the first storing medium, the write managing unit instructs the power managing unit to set the power in the area of the first storing medium shown by the address to on before the data is returned and set the power to off after the data is sheltered.

5. The data backup device according to claim 3, further comprising:
a power managing unit that sets the power of the first storing medium to on or off for each area; and
an interruption generating unit that generates an interruption in an external processor, wherein when the write managing unit detects that the external processor writes data in the area of the first storing medium, the write managing unit instructs the interruption generating unit to generate an interruption, and after the power in the area of the first storing medium is set to on before the data is returned in accordance with a handler executed in the processor, the write managing unit instructs the power managing unit to set the power to on after the data is sheltered.

6. The data backup device according to claim 1, further comprising:
a power state detecting unit that detects the state of a power in the first storing medium when a process to the first storing medium is carried out; and
an informing unit that informs a source requesting the process about the power of the first storing medium being turned off when the power of the first storing medium is turned off.

7. A data backup device that shelters data stored in a first storing medium in a second storing medium, said data backup device comprising:
a data transfer unit that shelters the data stored in the first storing medium in the second storing medium, generates identifying information exclusively coordinated with the contents of the data, and on the other hand, returns the sheltered data to the first storing medium, and evaluates the propriety of the sheltered data by using the identifying information;
an identifying information storing unit in which the generated identifying information is stored; and
a transfer managing unit that allows the data transfer unit to shelter the data when the data stored in the first storing medium is sheltered in the second storing medium, and on the other hand, allows the data transfer unit to return the data when the data stored in the second storing medium is returned to the first storing medium.

8. The data backup device according to claim 7, wherein the data transfer unit evaluates the propriety of the sheltered data by using the identifying information, and then, erases or replaces the identifying information stored in the identifying information storing unit by another value.

9. The data backup device according to claim 7, wherein when the data transfer unit returns the data, the data transfer unit evaluates the propriety of the data stored in the second storing medium by using the identifying information generated on the basis of the data stored in the second storing medium, when it is decided that the data is not proper data, the data transfer unit evaluates the propriety of the data stored in the second storing medium by using the identifying information generated on the basis of the data stored in the first storing medium, and when it is decided that the data is proper data, the data transfer unit informs a request source that the data whose propriety is certified is completely returned.

10. A data backup method in which a data backup device shelters data stored in a first storing medium to a second storing medium, said data backup method comprising:
a validity setting step that sets a flag showing whether the data stored in the second storing medium is valid or invalid to a validity when the data backup device shelters the data stored in the first storing medium to the second storing medium; and
an invalidity setting step that sets the flag to an invalidity when the data backup device returns the data stored in the second storing medium to the first storing medium.

11. A data backup method in which a data backup device shelters data stored in a first storing medium to a second storing medium, said data backup method comprising:
a generating step that generates identifying information exclusively coordinated with the contents of the data when the data backup device shelters the data stored in the first storing medium to the second storing medium;
a step that stores the generated identifying information in an identifying information storing unit by the data backup device; and
an evaluating step that evaluates the propriety of the sheltered data by using the identifying information when the data backup device returns the sheltered data to the first storing medium.

12. A data backup device in which units of the data backup device according to claim 1 are respectively mounted on an integrated circuit controlled by software.

13. Software that controls the integrated circuit according to claim 12.
